(19) United States
(12) Patent Application Publication
(10) Pub. No.: US 2025/0256632 A1
(43) Pub. Date: Aug. 14, 2025

(54) CUPHOLDER ASSEMBLIES

(71) Applicant: Precise Flight, Inc., Bend, OR (US)

(72) Inventors: Douglas Peter La Placa, Austin, TX (US); Tyler Tuttle, Remond, OR (US)

(73) Assignee: Precise Flight, Inc., Bend, OR (US)

(21) Appl. No.: 19/190,087

(22) Filed: Apr. 25, 2025

Related U.S. Application Data
(63) Continuation-in-part of application No. 18/651,588, filed on Apr. 30, 2024.
Application No. 18/651,588 is a continuation of application No. 18/316,655, filed on May 12, 2023, now Pat. No. 11,999,281.
Application No. 18/316,655 is a continuation of application No. 18/052,074, filed on Nov. 2, 2022, now Pat. No. 12,097,792.
Application No. 18/052,074 is a continuation-in-part of application No. 17/314,725, filed on May 7, 2021, now Pat. No. 12,089,758.
(60) Provisional application No. 63/021,308, filed on May 7, 2020.

(51) Int. Cl. B60N 3/10; A47G 29/093; B65D 41/06

(52) U.S. Cl. CPC B60N 3/102; A47G 29/093; B65D 41/06; Y10S 224/926; Y10T 403/7007

(57) ABSTRACT

Selectively engageable and interlocking cupholder assemblies are shown and disclosed. In some embodiments, the cupholder assembly includes a main member having opposed first and second end portions, and a bottom member pivotably attached to the first end portion of the main member. The bottom member includes a container receiver to receive a beverage container. The cupholder assembly additionally includes a top member pivotably attached to the second end portion of the main member. The top member includes an opening to receive the beverage container. The cupholder assembly further includes an over-centering mechanism that urges the bottom and top members toward an open position when the bottom and top members are between the open position and an over-center position, and that urges the bottom and top members toward a closed position when the bottom and top members are between the closed position and the over-center position.

### CROSS REFERENCE TO RELATED APPLICATIONS

This is a continuation-in-part application of U.S. patent application Ser. No. 18/651,588 filed on Apr. 30, 2024, which is a continuation of U.S. patent application Ser. No. 18/316,655 filed on May 12, 2023 and now U.S. Pat. No. 11,999,281, which is a continuation of U.S. patent application Ser. No. 18/052,074 filed on Nov. 2, 2022, which is a continuation-in-part of U.S. patent application Ser. No. 17/314,725 filed on May 7, 2021, which claims the benefit of U.S. Provisional Patent Application No. 63/021,308 filed on May 7, 2020. The complete disclosures of the above applications are hereby incorporated by reference for all purposes.

### BACKGROUND OF THE DISCLOSURE

The present disclosure is directed to a selectively engageable cupholder assembly, which may be used in an aircraft or vehicle interior while in movement.

In the aviation industry, passengers and pilots may opt to drink beverages and liquids while in flight. Oftentimes, turbulence may occur, resulting in drink spillage. Loose drinkware in the cockpits of airplanes, helicopters, and other vehicles cause spillage, leading to accidents. It is especially dangerous when the drinkware slips behind the pedals of the aircraft resulting in impeded operation of the aircraft/vehicle.

Additionally, spilled beverages in cockpits and other vehicles cause millions of dollars of damage to aircraft. Spills may be hard to remove and cause great inconvenience to flight personnel, especially if the spillage occurs in the cockpit. Finally, given the increase in aircraft sales and travel, there exists a need for solutions for the modern aircraft cabin.

What is desired, therefore, are cupholder assemblies that are suitable in preventing beverage-related accidents in an operating aircraft or any type of moving vehicle.

### BRIEF DESCRIPTION OF THE DRAWINGS

For a better understanding of the disclosure, and to show how the same may be carried into effect, reference will now be made, by way of example to the accompanying drawings, which:

FIG. 1 is an isometric view of an example of a cupholder assembly in a closed or folded position;

FIG. 2 is an isometric view of the cupholder assembly of FIG. 1 shown in an open or unfolded position;

FIG. 3 is an exploded view of the cupholder assembly of FIG. 1 showing an example of an over-center mechanism and shown without a backwall of a main member;

FIG. 4 is an isometric view of an example of a sliding member and biasing members of the over-center mechanism of FIG. 3;

FIG. 5 is a sectional view of the cupholder assembly of FIG. 1 taken along lines 5-5 in FIG. 1 and showing the cupholder assembly in the closed position;

FIG. 6 is another sectional view of the cupholder assembly of FIG. 5 taken along lines 6-6 in FIG. 5;

FIG. 7 is a sectional view of the cupholder assembly of FIG. 1 taken along lines 5-5 in FIG. 1 and showing the cupholder assembly in an intermediate or center position;

FIG. 8 is another sectional view of the cupholder assembly of FIG. 1 taken along lines 5-5 in FIG. 1 and showing the cupholder assembly in an open position;

FIG. 9 is a partial isometric view of the cupholder assembly of FIG. 1 showing an example of a tab and groove to secure a top member in an open position;

FIG. 10 is another sectional view of the cupholder assembly of FIG. 8 taken along lines 10-10 in FIG. 8;

FIGS. 11A-11C are partial sectional views showing pivoting of bias members as the sliding member moves between a distal position and a proximal position;

FIG. 12 is an isometric view of the cupholder assembly of FIG. 1 and an example of a beverage container; and

FIG. 13 is a partial view of a bottom portion of the beverage container of FIG. 12.

### DETAILED DESCRIPTION OF PREFERRED EMBODIMENTS

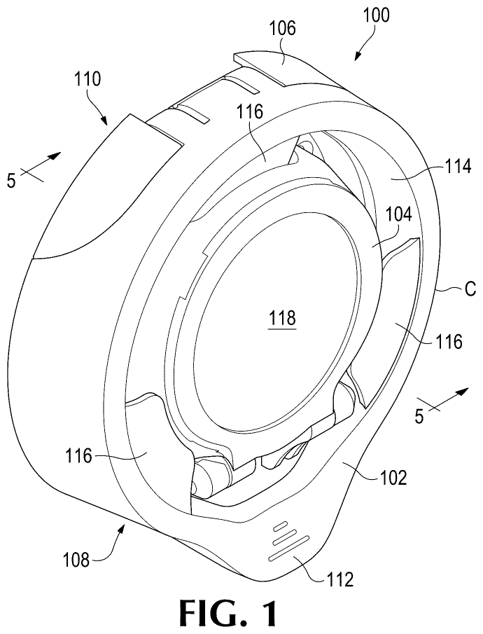

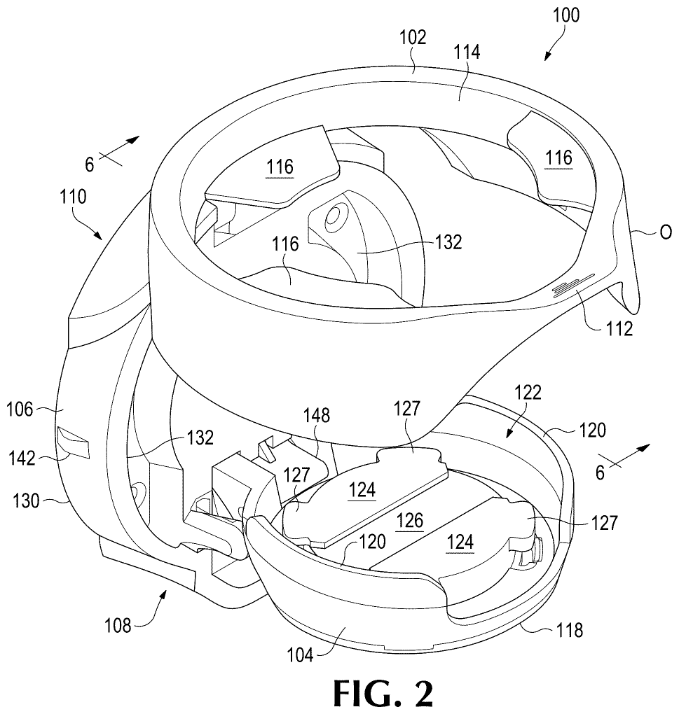

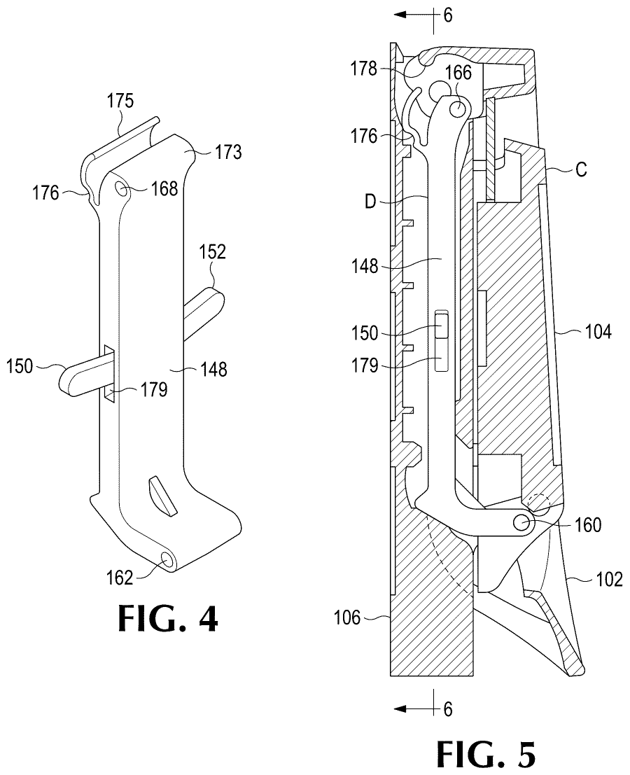

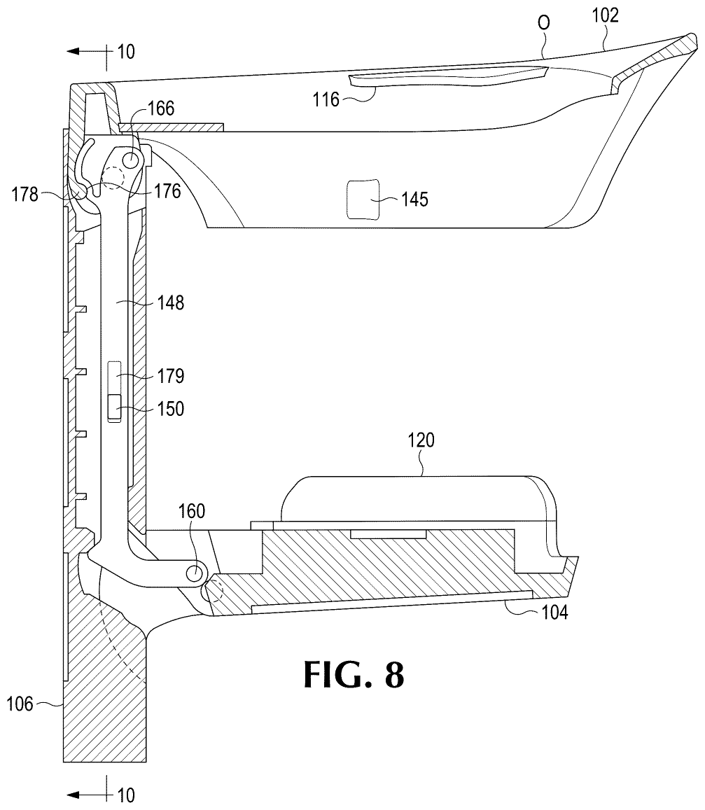

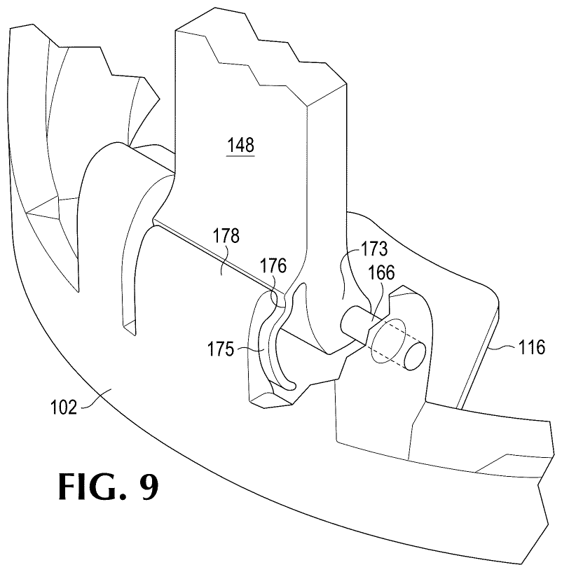

Referring to FIGS. 1-2, an example of a cupholder assembly 100 is shown, which can be used to hold beverages and bottled liquids in an aircraft. In some embodiments, the assembly 100 includes a top member 102, a bottom member 104, and a main member 106. In the example shown in FIGS. 1-10, the top, bottom, and main members are generally circular but may, in other examples, have other suitable shapes. Main member 106 includes opposed first and second end portions 108, 110. Top member 102 is pivotably attached or connected to second end portion 110 of the main member, while bottom member 104 is pivotably attached or connected to first end portion 108 of the main member. The top and bottom members are thus pivotable between a folded or closed position C (shown in FIG. 1) in which the top and bottom members are generally parallel to the main member, and an unfolded or open position O in which the top and bottom members are generally perpendicular to the main member to receive beverage or liquid containers. Because aircraft cupholder breakage is often caused by the user stepping on the cupholder by accident, allowing the three members to pivotably engage and fold into a unitary mass allows for increased structural strength and further prevents the members from breaking upon unwanted impact.

Top member 102 includes a handle portion 112 and an opening 114 to receive a beverage container. The top member also includes a plurality of spaced tabs 116 to extend toward the opening to assist in securing the beverage container inserted through the opening and supported by the bottom member. Bottom member 104 includes a bottom base 118, vertical walls 120 attached to, or formed with, the bottom base, and a container receiver 122 attached to and/or supported on the bottom base and disposed between the vertical walls. In the example shown in FIGS. 1-2, the container receiver includes two spaced lobes 124 defining a channel 126 therebetween. One or more spaced teeth 127 are generally circularly arranged and extend outward from each of lobes 124. In some embodiments, the teeth fit into corresponding circular aperture(s) of a beverage container (discussed further below).

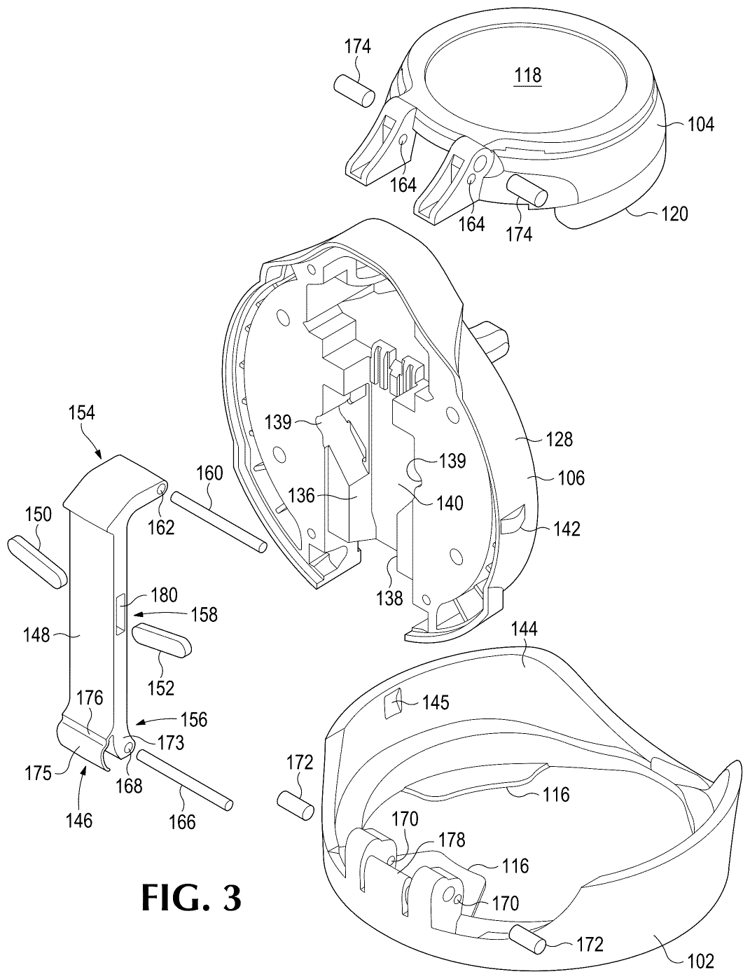

Referring to FIGS. 1-3, main member 106 includes a front plate or front wall 128 and an opposed back plate or back wall 130. The front wall includes opposed cavities 132 to receive vertical walls 120 of bottom member 104 when the top and bottom members are in the closed position. Disposed between front wall 128 and back wall 30 are opposed and spaced internal side walls 136, 138 with each of those side walls having an indentation 139 (as shown in FIG. 3). In the example shown, the internal side walls are generally perpendicular to the front and back walls and define a main channel 140 therebetween for a sliding member of the over-center mechanism (further discussed below). The main member also includes opposed locking protrusions 142. Internal wall 144 of top member 102 includes cavities 145 that receive the locking protrusions to secure the top member to the main member when the top member is in the closed position.

Referring to FIGS. 3-10, cupholder assembly 100 includes an over-center mechanism 146. The over-center mechanism biases or urges the top and/or bottom members toward either (1) open position O when the top and/or bottom members are between the open position and an over-center position OC, or (2) closed position C when the top and/or bottom members are between the closed position and the over-center position.

In the example shown in FIGS. 3-10, the over-center mechanism includes a push rod or sliding member 148, a first biasing member 150, and a second biasing member 152. The sliding member includes opposed first and second longitudinal end portions 154, 156 and a center portion 158 disposed between the opposed first and second end portions. In the example shown in FIGS. 3-10, the sliding member is generally L-shaped with the first end portion being generally perpendicular to the center and second end portions. First end portion 154 is pivotably connected to bottom member 104 via a pin 160 received in hole 162 of the first end portion and holes 164 of bottom member 104. Additionally, second end portion 156 is pivotably connected to top member 102 via a pin 166 received in hole 168 of the second end portion and holes 170 of top member 102. Pivot pins 160 and 166 are spaced from pivot pins 172 that pivotably connect the top member to the main member and from pivot pins 174 that pivotably connect the bottom member to the main member.

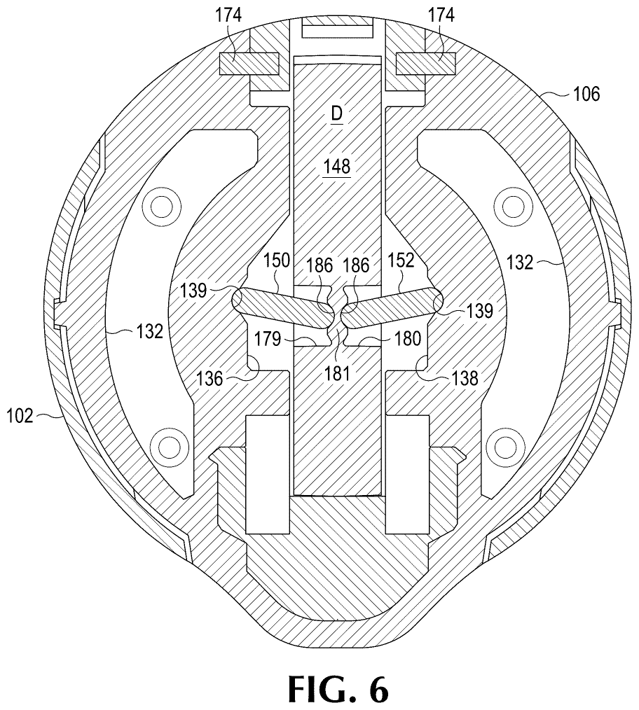

Second end portion 156 of sliding member 148 includes an end base 173 and an end tab 175 angled outwardly and spaced from the end base forming a channel therebetween. The end tab includes a groove 176 that receives a detent or main tab 178 from the main member when the top member is in the open position to secure the top member in the open position. In other words, the main tab is shaped and/or sized to be received in the groove. Center portion 158 includes opposed transverse first and second cavities 179, 180. As best shown in FIG. 6, a center wall 181 divides the first and second cavities. The center wall includes opposed first and second surfaces 182, 184 with each of those surfaces having an indentation 186.

In the example shown in FIGS. 3-10, first and second biasing members 150, 152 are in the form of planar dowels made of any suitable material(s), such as plastic. When the biasing members are made of plastic, suitable plastic materials include polycarbonate polymer and/or other suitable polymers, such as those with a flexural modulus of 1.8 to 3.2 gigapascals (GPa). Each of the first and second biasing members includes opposed first and second longitudinal ends 154, 156. The first ends are sized and/or shaped to be received in indentations 139 of side walls 136 and 138, while the second ends are sized and/or shaped to be received in indentations 186 of center wall 181. In the example shown in FIGS. 3-9, the first and second ends are rounded such that the first and second biasing members may be described as being “stadium-shaped.”

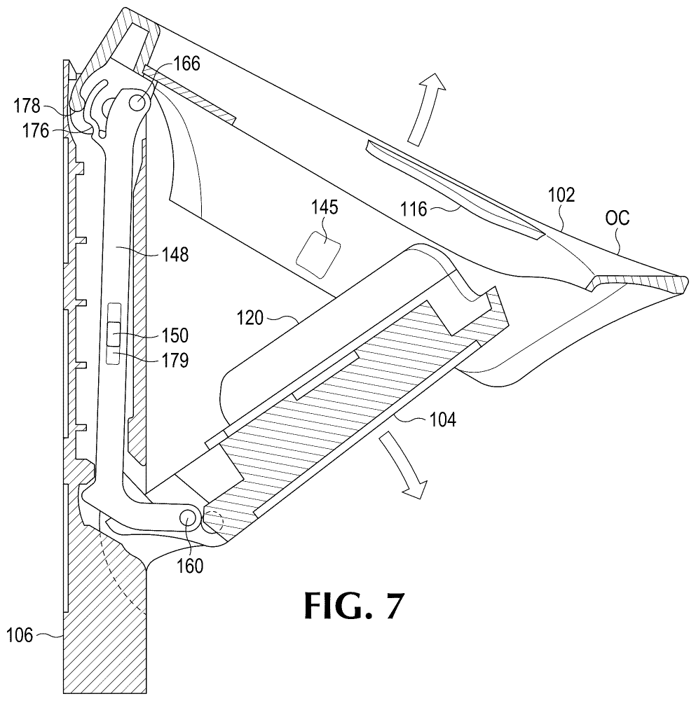

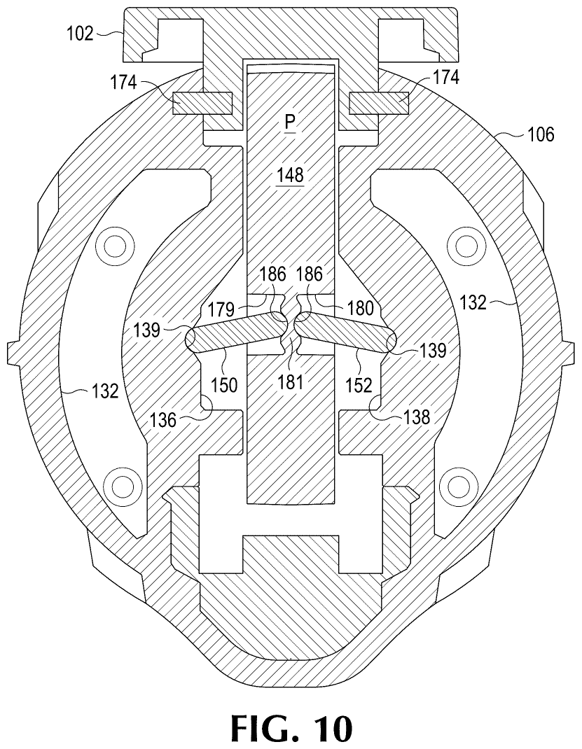

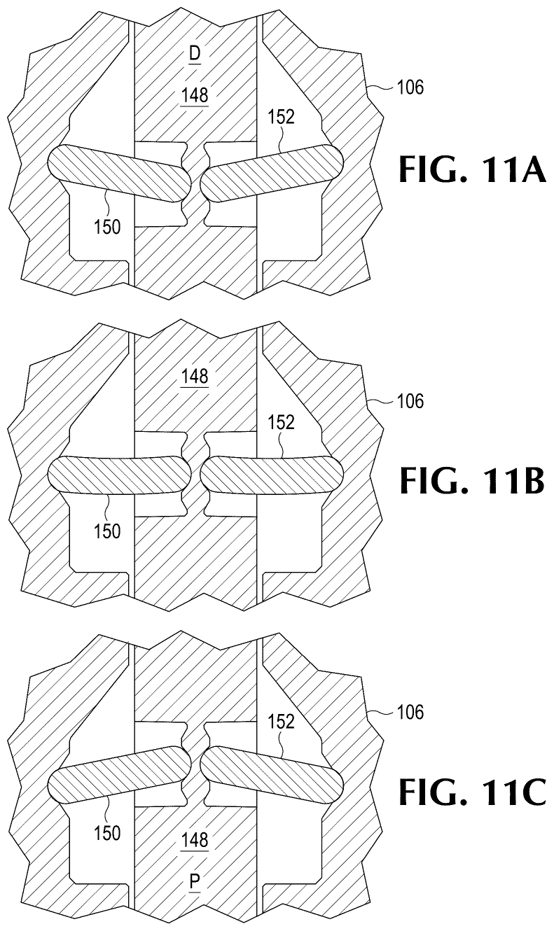

Starting from closed position C with the top and bottom members generally parallel to the main member, sliding member 148 is in a distal position D (as shown in FIGS. 6 and 11A). A user can grasp handle portion 112 of top member 102 and move the top member upward. Sliding member 148 moves toward a proximal position P and pivots the bottom member as the top member is pivoted. Until the top and bottom members are in over-center position OC, the first and second biasing members urge the top and bottom members toward the closed position. Once the top member and/or bottom member are moved past the over-center position (shown in FIGS. 7 and 11B), the first and second biasing members urge the top and bottom members toward the open position. When the top member and/or bottom member is moved to open position O, tab 178 is received in groove 176 to secure the top member in the open position and sliding member 148 is in the proximal position (as shown in FIGS. 10 and 11C). After using the cupholder assembly, the top and bottom members may be moved to the closed position by reversing the above steps. As best shown in FIGS. 11A-11C, first and second biasing members pivot in opposite directions as the sliding member moves between the distal position and the proximal position.

Cupholder assembly 100 may be easily integrated into the aircraft's existing beverage console design, allowing for minimal design work and maximum safety of beverages and drinkware. The assembly may also be available as an interior mounted module, so that it may be installed on the interior wall of the aircraft cabin. This option would allow for easy access to beverages by the user, while offering little obtrusion into aircraft cabin space while the assembly is fully engaged.

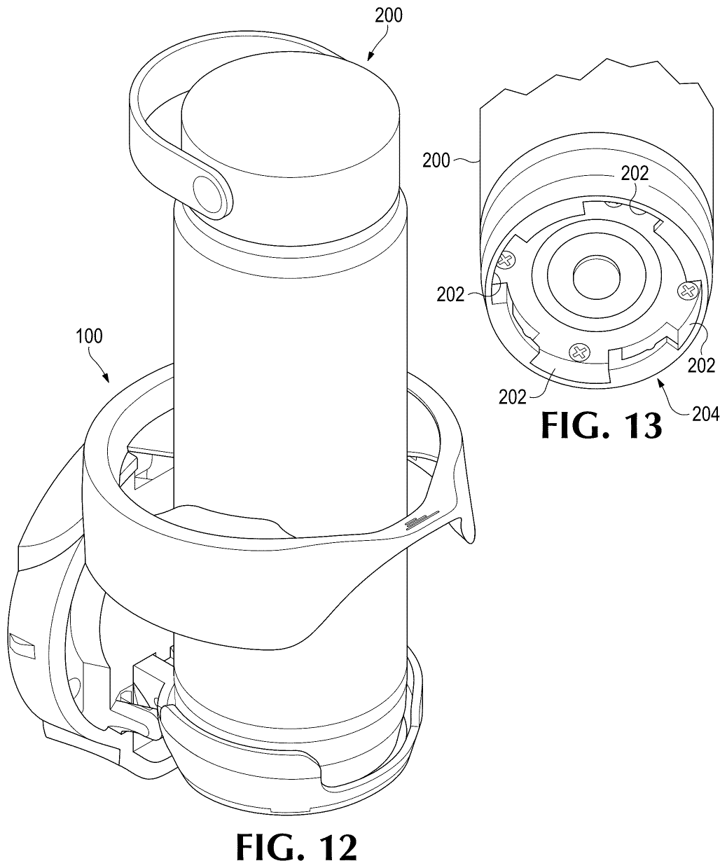

Referring to FIGS. 12-13, a water bottle 200 suitable for use with cupholder assembly 100 is shown. The water bottle is secured solely by engaging the recesses 202 of bottom 204 of the water bottle with teeth 127 of bottom member 104 (shown in FIG. 2). Although a particular water bottle is shown, any suitable water bottles and/or other beverage containers may be used with cupholder assembly 100.

Stated variously, disclosed herein is a cupholder assembly for holding a beverage container, comprising a bottom member defining a lower surface and a generally circular container receiver opposite the lower surface; one or more teeth arranged around said receiver; and a water bottle defining a circular aperture with dimensions generally conforming to the circular shape of the receiver, wherein the aperture defines locking recesses corresponding to the one or more teeth, and an outer wall with a height taller than said one or more teeth. The water bottle may interlock to said bottom member by radially engaging the teeth with said corresponding recesses. The bottom member defines one or more openings through which at least one fastening device may be inserted to mount said bottom member to a surface.

Also disclosed herein is a cupholder assembly for holding a beverage container, comprising a bottom member defining a lower surface and a generally circular container receiver opposite the lower surface; one or more teeth arranged around said receiver; and an outer wall with a height taller than said one or more teeth. The assembly may optionally include a circular aperture with dimensions generally conforming to the circular shape of the receiver; wherein the aperture defines locking recesses corresponding to said one or more teeth; and wherein said water bottle may interlock to said bottom member by radially engaging the teeth with said corresponding recesses. Optionally the outer wall is angled inwardly, with its widest dimensions nearest the lower surface of said bottom member and its narrowest dimensions nearest the receiver. Or, optionally, the outer wall protrudes normally from the lower surface of said member and said outer wall is tall enough to retain a container without radially engaging said one or more teeth. The assembly may further include a strap suitable to fasten or secure said bottom member to an object.

It will be appreciated that the disclosure is not restricted to the particular embodiment that has been described, and that variations may be made therein without departing from the scope of the disclosure as defined in the appending claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. A cupholder assembly, comprising:
(a) a main member having opposed first and second end portions;
(b) a bottom member pivotably attached to the first end portion of the main member, the bottom member having a container receiver to receive a beverage container;
(c) a top member pivotably attached to the second end portion of the main member, the top member having an opening to receive the beverage container, wherein the bottom and top members are pivotable between an open position in which the bottom and top members are generally perpendicular to the main member allowing the bottom and top members to receive the beverage container, and a closed position in which the bottom and top members are generally parallel to the main member; and
(d) an over-centering mechanism that urges the bottom and top members toward the open position when the bottom and top members are between the open position and an over-center position, and that urges the bottom and top members toward the closed position when the bottom and top members are between the closed position and the over-center position.

2. The cupholder assembly of claim 1, wherein the main member includes opposed front and back walls and opposed first and second internal side walls disposed between the front and back walls and generally perpendicular to the front and back walls, and wherein the first and second internal side walls define a channel therebetween.

3. The cupholder assembly of claim 2, wherein the first and second internal side walls include corresponding first and second indentations, and wherein the over-centering mechanism includes:
a sliding member slidably received in the channel, the sliding member having opposed first and second longitudinal end portions and a center portion disposed between the first and second end portions, the first end portion being pivotably connected to the bottom member and the second end portion being pivotably connected to the top member, and the center portion having opposed transverse first and second cavities;
a first biasing member having opposed first and second longitudinal ends, the first end being received in the first indentation, and the second end being received in the first cavity; and
a second biasing member having opposed third and fourth longitudinal ends, the third end being received in the second indentation, and the fourth end being received in the second cavity.

4. The cupholder assembly of claim 3, wherein the sliding member slides among a proximal position in which the bottom and top members are in the open position, a distal position in which the bottom and top members are in the closed position, and center position between the proximal and distal positions in which the bottom and top members are in the over-center position.

5. The cupholder assembly of claim 4, wherein the first and second biasing members pivot in opposite directions when the sliding member moves between the proximal and distal positions.

6. The cupholder assembly of claim 4, wherein the first and second biasing members are compressed when the sliding member is in the center position relative to when the sliding member is in either the proximal position or the distal position.

7. The cupholder assembly of claim 3, wherein each of the first and second biasing members is only a planar dowel.

8. The cupholder assembly of claim 7, wherein the planar dowel is plastic.

9. The cupholder assembly of claim 8, wherein each of the planar dowels is stadium-shaped with longitudinal ends that are shaped to be received in the corresponding indentation and the corresponding cavity.

10. The cupholder assembly of claim 3, further comprising a first pivot pin that pivotably connects the first end portion of the sliding member to the bottom member, and at least a second pivot pin that pivotably connects the main member to the bottom member, wherein the first pivot pin is spaced from and parallel to the at least a second pivot pin.

11. The cupholder assembly of claim 10, further comprising a third pivot pin that pivotably connects the second end portion of the sliding member to the top member, and at least a fourth pivot pin that pivotably connects the main member to the top member, wherein the third pivot pin is spaced from and parallel to the at least a fourth pivot pin.

12. The cupholder assembly of claim 3, wherein the second end portion of the sliding member includes a groove and the top member includes a tab that is shaped to be received in the groove when the top member is in the open position.
